(19) United States
(12) Patent Application Publication
(10) Pub. No.: US 2026/0284863 A1
(43) Pub. Date: Sep. 24, 2026

(54) CONVEYING APPARATUS AND CONVEYING SYSTEM

(71) Applicant: ABB SCHWEIZ AG, Baden (CH)

(72) Inventors: Wenzhen Liu, Shanghai (CN); Songhua Yang, Shanghai (CN)

(21) Appl. No.: 19/678,913

(22) Filed: May 15, 2026

Related U.S. Application Data
(63) Continuation of application No. PCT/CN2023/138160, filed on Dec. 12, 2023.

(51) Int. Cl. B25J 9/00; B25J 9/10; B25J 18/00

(52) U.S. Cl. CPC B25J 9/0009; B25J 9/104; B25J 18/00

(57) ABSTRACT

Example embodiments of the present disclosure relate to a conveying apparatus and a corresponding conveying system. The conveying apparatus includes a fixed base; a moving frame coupled to the fixed base and adapted to move along a moving direction with respect to the fixed base; a first belt coupled to the moving frame at both ends, a second belt having a ring form and wound on two fixed wheels at both ends, the fixed wheels being fixedly mounted to the moving frame, the second belt (34) coupled to the fixed base; and a grasping component coupled to the second belt and configured to grasp an object and move the object to a predetermined position.

### FIELD

Example embodiments of the present disclosure generally relate to the industrial field, and more particularly, to a conveying apparatus and a corresponding conveying system.

### BACKGROUND

Currently, the transfer of sheet materials between presses in automobile stamping lines is generally achieved through robots and linear seven-axis robots. For large-size stamping components, large linear seven-axis robots have many advantages. However, for small-size sheet metal components, large linear seven-axis robots have a larger physical size and higher price, which are not advantageous.

### SUMMARY

In general, example embodiments of the present disclosure provide a conveying apparatus and a corresponding conveying system, which address the existing problems and/or any potential problems.

In a first aspect, a conveying apparatus is provided. The conveying apparatus comprises a fixed base; a moving frame coupled to the fixed base and adapted to move along a moving direction with respect to the fixed base; a first belt coupled to the moving frame at both ends; a second belt in a ring form and wounded on two fixed wheels at both end, the fixed wheels fixed mounted to the moving frame, the second belt coupled to the fixed base; and a grasping component coupled to the second belt and configured to grasp an object to a predetermined position.

According to example embodiments of the present disclosure, the overall dimension of the conveying apparatus is small, which may adapt to a variety of scenarios.

In some example embodiments, the conveying apparatus further comprises a motor coupled to the fixed base and configured to drive the moving frame.

In some example embodiments, the conveying apparatus further comprises a wheel driven by the motor, and the first belt meshes with the wheel.

In some example embodiments, the moving frame is of ring form.

In some example embodiments, the conveying apparatus further comprises a cable chain provided at an outer edge of the moving frame and configured to contain air cable and/or power cable to drive the moving frame, wherein the cable chain is provided in a horizontal plane.

In some example embodiments, the fixed base, the moving frame and/or the grasping component is made of carbon fiber or metal alloy.

In a second aspect, a conveying system is provided. The conveying system comprises a mechanical arm; and a conveying apparatus of the first aspect, the fixed base is fixed coupled to the mechanical arm.

In some example embodiments, the mechanical arm is controlled and driven by a six-axis industrial robot.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a perspective view of the conveying apparatus in accordance with an example embodiment of the present disclosure;

FIG. 2 illustrates a perspective view of the conveying apparatus in accordance with an example embodiment of the present disclosure, showing a different position from that shown in FIG. 1; and

FIG. 3 illustrates a perspective view of the conveying apparatus in accordance with an example embodiment of the present disclosure, showing a different position from those shown in FIGS. 1 and 2.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

A variety of approaches have been proposed to convey the objects to desired positions in goods transferring industry. As described above, the conventional approaches still have many disadvantages. For example, the existing conveying apparatus still covers an area of fairly large, which is inconvenient to get widely used in more industrial applications. Moreover, the cost of the existing conveying apparatus is still high for the users.

At least to address the problem existed in the conventional approaches, the present disclosure proposes a solution involving a conveying apparatus and a corresponding conveying system, which greatly saves the space occupied by the conveying apparatus and the cost.

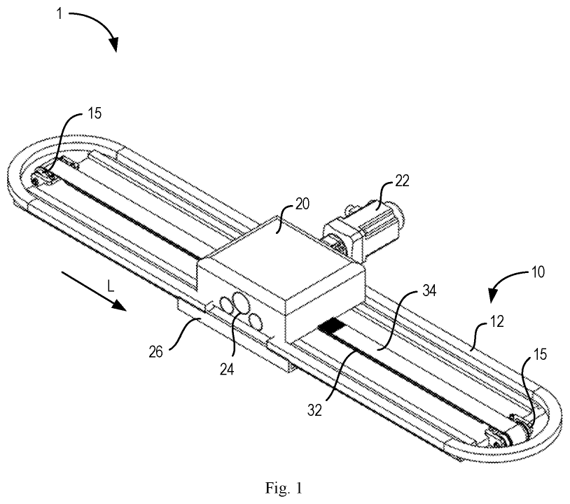

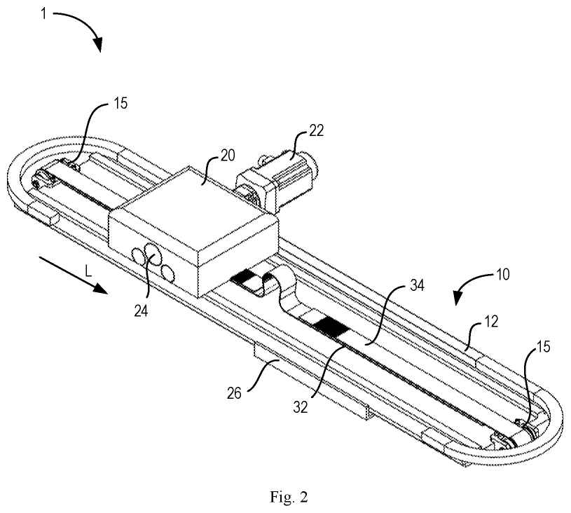

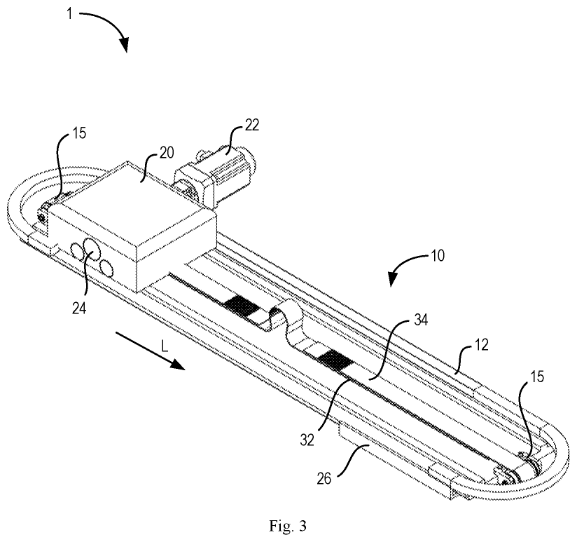

Example embodiments of the present disclosure will be described in more detail hereinafter in accordance with FIGS. 1-3. With reference to FIG. 1, which illustrates a perspective view of the conveying apparatus 1 in accordance with an example embodiment of the present disclosure. FIG. 2-3 each illustrates a perspective view of the conveying apparatus 1, showing different positions from that shown in FIG. 1.

As can be seen from FIG. 1, the conveying apparatus 1 generally includes a moving frame 10 and a fixed base 20. The moving frame 10 is configured to move in a moving direction L or opposite to the moving direction L with respect to the fixed base 20. The fixed base 20 can be mounted to a mechanical arm of a robot (not shown) and the fixed base 20 can be regarded as motionless in the present disclosure. A motor 22 is fixedly mounted to the fixed base 20 and may be designed to drive a wheel 24.

The conveying apparatus 1 further includes a first belt 32 and a second belt 34. The first belt 32 is coupled to the moving frame 10 in both ends and is coupled to the wheel 24 in the middle. In some example embodiments, the first belt 32 may be clamped by two clamping components fixed on the moving frame 10 to allow the moving frame 10 to move together with the first belt 32. In this way, when the wheel 24 is driven by the motor 22, the wheel 24 may cause the moving frame 10 together with the first belt 32 to move along the moving direction L or opposite to the moving direction L by means of the first belt 32. In the illustrated embodiments, the second belt 34 may be placed above the first belt 32. Yet, the movement of the first belt 32 will not influence the movement of the second belt 34. The second belt 34 may be of a ring form and it may be wounded around two fixed wheels 15 provided at both ends of the moving frame 10. The second belt 34 may be coupled to the fixed base 20. Since the fixed base 20 can be regarded as motionless, the second belt 34 coupled to the fixed base 20 may be regarded as fixed at its one end. In this way, when the second belt 34 is rotated around the fixed wheels 15, the fixed wheels 15 may act as a movable pulley.

A grasping component 26, which is configured to grasp an object to the desired position, is coupled to the second belt 34. As discussed above, since the fixed wheel 15 may act as a movable pulley, the moving distance of the grasping component 26 (with reference to FIGS. 1-3) may be twice of the moving distance of the moving frame 10 (with reference to FIGS. 1-3). In this way, the moving distance of the object may be enhanced. In other words, if the moving distance of the object to be handle is fixed, the size of the moving frame 10 can be made smaller to make the moving frame 10 and the conveying apparatus 1 much more compact.

In some example embodiments, the moving frame 10 may be made of carbon fiber. In some example embodiments, the fixed base 20 may be made of carbon fiber. In some example embodiments, the grasping component 26 may be made of carbon fiber. In other example embodiments, the moving frame 10, the fixed base 20 and/or the grasping component 26 may include engineering plastics. It is to be understood that the specific materials of the moving frame 10, the fixed base 20 and/or the grasping component 26 are not limited to embodiments of the present disclosure. For example, the fixed base 20, the moving frame 10 and/or the grasping component 26 may be made of metal alloy such as aluminum alloy. In this way, the whole conveying apparatus 1 may be light in weight.

Also, by using pulley structure, the overall lightweight can be ensured. More importantly, the movement direction of the cable chain 12 is moving along the moving direction L, i.e., in the horizontal direction, making the thickness of the whole conveying apparatus 1 in the vertical direction very small, which can be applied to very small mold openings while also having good rigidity to meet the requirements of larger vertical loads.

According to the example embodiments of the present disclosure, the motor 22 may drive the wheel 24 to rotate. Since the first belt 32 meshes the wheel 24, the first belt 32 can be actuated to move along or opposite to the moving direction L. Owing to the fact that the both ends of the first belt 32 is fixed mounted to the moving frame 10, the moving frame 10 may be driven to move along or opposite to the moving direction L with respect to the fixed base 20. As can be seen from FIG. 1, the movement of the moving frame 10 may drive the fixed wheels 15 to move, which may act as a movable pulley. Since the second belt 34 is wounded around the fixed wheels 15, the moving distance of the grasping component 26 may be twice of the moving distance of the moving frame 10.

In some example embodiment, the moving frame 10 may be of a ring form. It is to be understood that this is illustrative, rather than restrictive, depending on the actual scenarios. In some example embodiments, as can be seen from FIG. 1, the conveying apparatus 1 may further comprise a cable chain 12 provided at an outer edge of the moving frame 10. The cable chain 12 may be configured to contain air cable and/or power cable to drive the moving frame 10. In this way, the space around the moving frame 10 can be fully utilized.

In a second aspect, the present disclosure proposes a conveying system. The conveying system may comprise a mechanical arm and a conveying apparatus 1 described above. The fixed base 20 may be fixed coupled to the mechanical arm. In some example embodiments, the mechanical arm is controlled and driven by a six-axis industrial robot. In this way, the conveying apparatus 1 may be regarded as a seventh axis. The conveying apparatus 1 according to the present disclosure may have less footprint.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A conveying apparatus comprising:
a fixed base;
a moving frame coupled to the fixed base and adapted to move along a moving direction with respect to the fixed base;
a first belt coupled to the moving frame at both ends;
a second belt in a ring form and wounded on two fixed wheels at both ends, the fixed wheels fixedly mounted to the moving frame, the second belt coupled to the fixed base; and
a grasping component coupled to the second belt and configured to grasp an object to a predetermined position.

2. The conveying apparatus of claim 1, further comprising a motor coupled to the fixed base and configured to drive the moving frame.

3. The conveying apparatus of claim 2, further comprising a wheel driven by the motor and the first belt meshes with the wheel.

4. The conveying apparatus of claim 1, wherein the moving frame is of ring form.

5. The conveying apparatus of claim 1, further comprising a cable chain provided at an outer edge of the moving frame and configured to contain air cable and/or power cable to drive the moving frame, wherein the cable chain is provided in a horizontal plane.

6. The conveying apparatus of claim 1, wherein the fixed base, the moving frame and/or the grasping component is made of carbon fiber or metal alloy.

7. A conveying system, comprising:
a mechanical arm; and
a conveying apparatus of claim 1, wherein the fixed base is fixedly coupled to the mechanical arm.

8. The conveying system of claim 7, wherein the mechanical arm is controlled and driven by a six-axis industrial robot.
